(19) United States
(12) Patent Application Publication
(10) Pub. No.: US 2024/0421421 A1
(43) Pub. Date: Dec. 19, 2024

(54) HV BATTERY HAVING A DEGASSING DEVICE WITH AT LEAST ONE UNFOLDABLE AND/OR FLEXIBLE POUCH

(71) Applicant: Dr. Ing. h.c. F. Porsche Aktiengesellschaft, Stuttgart (DE)

(72) Inventor: Dominik Grass, Bietigheim-Bissingen (DE)

(73) Assignee: Dr. Ing. h.c. F. Porsche Aktiengesellschaft, Stuttgart (DE)

(21) Appl. No.: 18/740,584

(22) Filed: Jun. 12, 2024

(30) Foreign Application Priority Data
Jun. 14, 2023 (DE) 102023115436.2

(51) Int. Cl. H01M 50/358; B60L 50/64; H01M 50/383

(52) U.S. Cl. CPC H01M 50/358; B60L 50/64; H01M 50/383; H01M 2220/20

(57) ABSTRACT

An HV battery includes at least one battery module having (i) a degassing valve or a degassing opening and (ii) a degassing device, which is coupled to the degassing valve or the degassing opening, and is configured to dissipate gas exiting the battery module in the event of damage. The degassing device includes at least one unfoldable and/or flexible pouch, which is coupled to an outlet of the degassing device. An electric vehicle includes the HV battery, as well as a use of the unfoldable and/or flexible pouch.

### CROSS-REFERENCE TO RELATED APPLICATION

This application claims priority to German Patent Application No. 10 2023 115 436.2, filed Jun. 14, 2023, the content of such application being incorporated by reference herein in its entirety.

### FIELD OF THE INVENTION

The present invention relates to an HV (high voltage, e.g., 400-1000 volts or 600-900 volts or 800 volts) battery having a degassing device with at least one unfoldable and/or flexible pouch. Furthermore, the invention relates to an electric vehicle equipped therewith, as well as to the use of at least one unfoldable and/or the expandable pouch according to aspects of the invention.

### BACKGROUND OF THE INVENTION

HV batteries, in particular traction batteries in an electric vehicle, typically comprise a plurality of battery modules in which a plurality of battery cells are in turn arranged and electrically connected to one another. Lithium-ion cells are most commonly used as battery cells.

During operation of an HV battery, numerous disruptive events may cause one or more battery cell(s) therein to heat up to a temperature above their specified operating range, resulting in degassing of the battery cell(s). Such disruptive events include, for example, a short circuit between the electrodes of the battery cell, a charging process with a charging current that is too high or a high ambient temperature, possibly coupled with a simultaneous high charging or discharging load on the battery. Overheating of the battery cell triggers unwanted chemical reactions in the battery cell, which can lead to a so-called thermal runaway. In particular, the electrolyte within the closed battery cell can decompose and change into a gaseous state, which can cause the pressure within the hermetically sealed battery cell to increase sharply in a relatively short time. If no countermeasures are taken, the battery cell may burst, which can destroy not only the affected battery cell but also adjacent battery cells.

In order to prevent the battery cell from bursting, it is usually provided with a safety valve that opens when a limit pressure is reached within the battery cell, thus allowing a controlled reduction of the pressure within the battery cell. The hot gas then initially flows inside the corresponding battery module and can be buffered therein. If a limit pressure is exceeded within the battery module, a safety valve of the battery module opens and the hot gas is discharged to the outside environment by means of a degassing device in order to prevent the battery module or battery from bursting.

A degassing device with a cell degassing channel for removing gases from a motor vehicle battery, comprising at least one battery cell, is known from publication DE 10 2021125189 A1, which is incorporated by reference herein, wherein hot gas exiting during a thermal runway of a battery cell is conducted to the rear region of an electric vehicle by means of a degassing device in order to be discharged there to the outside environment. According to the publication, the gas to be removed is thus directed to a non-critical region of the motor vehicle at regions known from combustion vehicles for harmful gases to reach the outside environment from the vehicle.

Publication DE 10 2021208376 A1, which is incorporated by reference herein, discloses a battery system and a device for degassing and/or cooling and/or extinguishing the battery system of the vehicle having at least one conduit element, wherein the conduit element comprises a hose which is arranged rolled up in the vehicle in a transport state. Furthermore, at least one activation means is provided, by means of which the conduit element can be brought into a useful state projecting from the vehicle as required. By means of the conduit element, hot gases may be discharged at a location spaced apart from the vehicle and/or an extinguishing agent for cooling and/or extinguishing the battery system may be introduced from a location spaced apart from the vehicle.

### SUMMARY OF THE INVENTION

Described herein is a traction battery that reduces the potential for injury to people from hot gas exiting a battery module during a thermal runway.

According to aspects of the present invention, an HV battery is provided comprising at least one battery module having a degassing valve or a degassing opening and a degassing device which is coupled to the degassing valve or the degassing opening and configured to discharge gas exiting the battery module in the event of damage. The degassing device comprises at least one unfoldable and/or flexible pouch coupled to an outlet of the degassing device. In the context of this invention, the pouch may be a hose.

The unfoldable and/or flexible pouch is folded and/or compressed in its normal state and/or in the unactivated state. The unfoldable pouch or hose may be a rolled-up pouch or a rolled-up hose (which may also be flexible). During a thermal runway, the hot gas exiting the battery module is directed into the pouch by means of the degassing device. As a result, the pressure inside the pouch increases, causing it to unfold and/or expand. The hot gas exiting the battery module is collected in the pouch. The pouch may be made of a material with a very small thermal conductivity coefficient, so that its surface only heats up slowly. Overall, the risk of personal injury may be minimized by the controlled collection of the hot gas in the unfolded and/or expanded pouch. The material of the pouch may also be heat resistant. In a further embodiment, the pouch may be made of a material with a very high thermal conductivity coefficient in order to absorb the heat of the hot gas and efficiently dissipate it to the environment, thereby minimizing the reaction property of the gas.

Unfolding the pouch may mean a mechanical unfolding of the pouch in which the folded or folded collapsed parts of the surface of the pouch are unfolded, thereby increasing the internal volume described by the pouch. An expansion of the pouch may mean an increase in its internal volume due to the elasticity of the pouch material. An expansion of the pouch may occur in particular when the pressure within the pouch is higher than the external pressure of the pouch.

The dimension of the pouch, in particular its internal volume, may be matched to the battery or to the amount of escaping gas expected during a thermal runway of a battery cell. The at least one pouch may be arranged in an inactivated and thus compact or collapsed state at an outlet opening of the degassing device. During a thermal event, the hot gas is used to unfold and/or expand the pouch. The hot gases are then stored in the at least one pouch and cannot cause further damage to property, personal injury or ignite other objects. The gases can therefore not reach the environment and can be transported away and disposed of in the bag in a defined manner.

According to further embodiments of the HV battery, the degassing device may comprise a pipe system. The pipe system may be differently designed and adapted to the design of the HV battery. Thus, the pipe system may comprise a chamber connected to the degassing valves of the battery modules. The chamber may function as a buffer and initially collect hot gas exiting a battery module. The pipe system may, with or without an intermediate chamber, provide a connection between the degassing valves of the battery modules and an inlet into the at least one pouch.

According to further embodiments of the HV battery, the pouch may comprise a pressure relief valve or defined openings. The pressure relief valve may function as a safety valve to prevent uncontrolled bursting of the pouch. It may be configured to open in a controlled manner upon reaching a limit pressure to reduce the pressure within the unfolded and/or expanded pouch. If the pressure falls below a second limit pressure, the pressure relief valve may close again in order to limit the amount of hot gas released to the outside environment to the lowest possible level.

According to further embodiments of the HV battery, the pressure relief valve may be arranged on the pouch such that it is arranged on its top side in the unfolded and/or expanded state of the pouch. The top side of the pouch may correspond to a surface of the pouch which, in a state of the degassing device installed in an electric vehicle, is directed upwards, i.e., towards the sky, or is turned away from the ground on which the vehicle is standing.

According to aspects of the invention, an electric vehicle is further provided comprising a previously described HV battery, wherein the degassing device is arranged with the unfoldable and/or flexible pouch coupled thereto in the electric vehicle, such that the pouch protrudes from the body of the electric vehicle in the unfolded and/or expanded state. For this purpose, an opening may be provided on the body through which the pouch can be unfolded and/or expanded outwards, i.e., out of the vehicle body.

According to further embodiments of the electric vehicle, the unfoldable and/or flexible pouch may be configured in such a way it protrudes from the body due to the gas exiting the degassing device in the event of damage, such that the pressure relief valve is arranged on its top side. The top side may correspond to the surface of the pouch directed towards the sky or facing away from the surface of the earth. This means that in the event of controlled outgassing of the pouch, the hot gas may flow out in a direction away from the vehicle and possibly away from people standing around.

According to further embodiments of the electric vehicle, the unfoldable and/or expandable pouch may have a shape such that its top side is arranged above the vehicle roof in the unfolding and/or expanded state. For example, in the activated state (i.e., the expanded and/or unfolded state), the pouch may have a cuboid or cylindrical shape with its top side higher than the vehicle roof. Preferably, the height of the pouch in the activated state may be 2 m or more. Alternatively, the pouch shape may be such that its top side is at a height of at least 2 m above the surface of the earth. This may be achieved in combination with the position of the opening through which the pouch extends out of the body,

According to aspects of the invention, there is further provided a use of at least one unfoldable and/or expandable pouch which is coupled to a degassing device of an HV battery in order to collect gases discharged by means of the degassing device in the event of damage, which exit or have exited the at least one battery module.

It is understood that the aforementioned features and the features yet to be explained in the following can be used not only in the respectively specified combination, but also in other combinations, or on their own, without leaving the scope of the present invention.

### BRIEF DESCRIPTION OF THE DRAWINGS

Additional advantages and configurations of the invention follow from the description and the enclosed drawings.

FIG. 1 shows an exemplary embodiment of the HV battery in the installed state, wherein the pouches are in an unactivated (deactivated) state.

FIG. 2 shows an exemplary embodiment of the HV battery in FIG. 1, wherein the pouches are in an activated state.

### DETAILED DESCRIPTION OF THE INVENTION

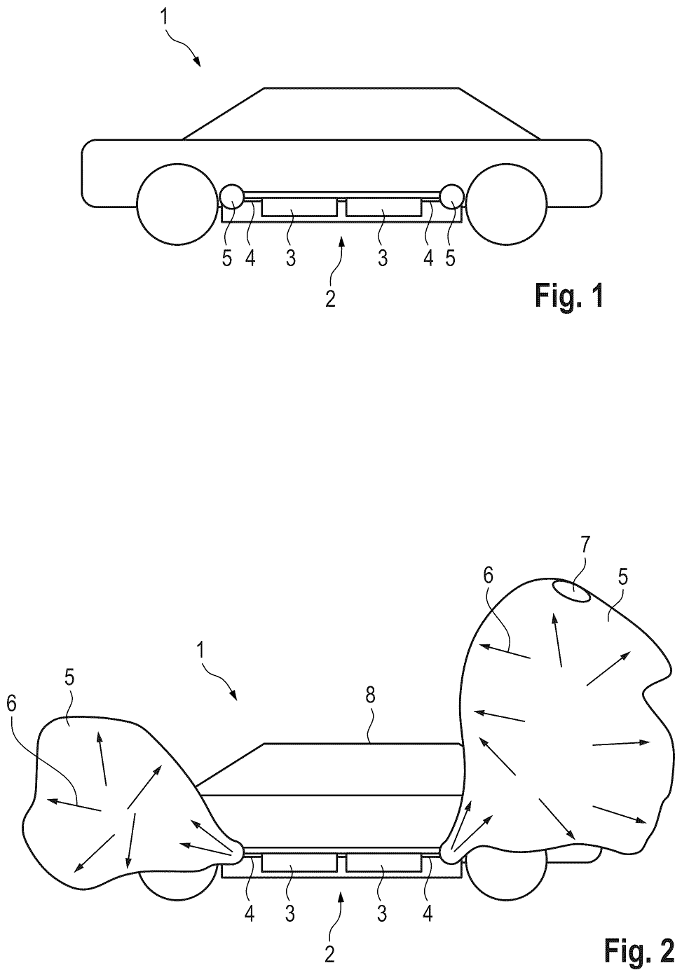

FIG. 1 shows an exemplary embodiment of an HV battery 2 according to aspects of the present invention, wherein the HV battery 2 is installed in an electric vehicle 1. The HV battery 2 comprises two battery modules 3 and is arranged in the underbody of the electric vehicle 1. The degassing valves of the battery modules 3 are coupled by means of the degassing device 4, which comprises pipelines, to outlets via which hot gases can normally be selectively discharged from the battery cell and the battery module 3 in the event of a thermal runway of one of the battery cells in a battery module 3. Overall, the degassing device 4 creates a common fluid-mechanical and outwardly sealed connection between the two outlets of the degassing device 4 and the two battery modules 3. In the HV battery 2 according to aspects of the invention, an unfoldable and/or flexible pouch 5 is arranged at each of the two outlets shown (not explicitly shown in the figures) of the degassing device 4, each of which is arranged in the region of the wheel housing. In FIG. 1, the two pouches 5 are not activated, i.e., they are in a collapsed and unexpanded state.

In FIG. 2, the embodiment of the HV battery in FIG. 1 is illustrated, but during a thermal event. During a thermal runway of one or more a battery cells, the pouches 5 unfold and/or expand and are thus in their activated state. In this state, they collect the hot gases from the at least one damaged battery cell represented by arrows 6. The hot gases thus do not enter the environment in an uncontrolled manner. The degree of unfolding and/or expansion as well as the size of the two pouches 5 may be different, as indicated in FIG. 2.

A pressure relief valve 7 is provided on the top side of the activated right pouch 5, which is arranged in the area of the sill. When a limit pressure is reached in the bag 5, the pressure relief valve 7 opens, allowing the internal pressure to be reduced in a controlled manner. The shape of the pouch 5 is selected such that the pressure relief valve 7 is arranged above the roof 8 of the electric vehicle 1 when it is triggered. The pressure relief valve 7 may be provided to prevent the pouch 5 from bursting in the activated state.

What is claimed is:

1. An HV battery comprising:
at least one battery module having a degassing valve or a degassing opening;
a degassing device, which is coupled to the degassing valve or the degassing opening, and is configured to dissipate gas exiting from the battery module in an event of damage;
wherein the degassing device comprises at least one unfoldable and/or flexible pouch, which is coupled to an outlet of the degassing device.

2. The HV battery according to claim 1, wherein the degassing device comprises a pipe system.

3. The HV battery according to claim 1, wherein the pouch comprises a pressure relief valve or defined openings.

4. The HV battery according to claim 3, wherein the pressure relief valve is arranged on the pouch such that the pressure relief valve is arranged at a top side of the pouch in the unfolded and/or expanded state of the pouch.

5. An electric vehicle comprising:
the HV battery according to claim 1,
wherein the degassing device is arranged with the unfoldable and/or flexible pouch coupled thereto in the electric vehicle, such that the pouch protrudes from a body of the electric vehicle in an unfolded and/or expanded state of the pouch.

6. The electric vehicle according to claim 5, wherein the unfoldable and/or flexible pouch is configured to protrude from the body, due to the gas exiting the degassing device in the event of damage, such that the pressure relief valve is arranged on a top side of the pouch.

7. The electric vehicle according to claim 5, wherein the unfoldable and/or expandable pouch has a shape such that a top side of the pouch is arranged above the vehicle roof in the unfolding and/or expanded state of the pouch.

8. A method of using at least one unfoldable and/or expandable pouch which is coupled to a degassing device of an HV battery, said method comprising:
in an event of damage, collecting gases within the pouch that have exited the HV battery via the degassing device.
